(19) United States
(12) Patent Application Publication
(10) Pub. No.: US 2017/0177739 A1
(43) Pub. Date: Jun. 22, 2017

(54) PREDICTION USING A DATA STRUCTURE

(71) Applicant: Intel Corporation, Santa Clara, CA (US)

(72) Inventors: Kalpana A. Algotar, Chandler, AZ (US); Addicam V. Sanjay, Gilbert, AZ (US)

(73) Assignee: Intel Corporation, Santa Clara, CA (US)

(21) Appl. No.: 14/979,300

(22) Filed: Dec. 22, 2015

(51) Int. Cl. G06F 17/30; G06N 99/00; G06N 5/04

(52) U.S. Cl. CPC G06F 17/30958; G06F 17/30949; G06N 5/04; G06N 99/005

(57) ABSTRACT

Techniques for prediction using multimap is described herein. The method for multimap prediction can include generating a user profile graph in the memory device based on user action input received at an input device. The method for multimap prediction can also include matching a user profile graph stored in the memory device to a subgraph of a multimap graph, both comprising nodes and edges, wherein each node indicates at least one of an activity input and a keyword. The method can include providing access to a multimap prediction in the memory device based on the user action input and the subgraph of the multimap graph.

### TECHNICAL FIELD

The present techniques relate generally to prediction using a data structure. More specifically, the present techniques relate to enabling a user or application to access to a prediction made through use of a multimap based on stored user input.

### BACKGROUND ART

Users of computing technology such as mobile phones, tablets, or other computing devices can make purchases, read text, provide input, and many other similar actions. Computing technology can display content or provide feedback based on a user's interactions with the computing technology. The ability of computing technology to predict a user preference, action, or selection can be used to aid in a computing device in presenting more useful feedback or content to a user.

### BRIEF DESCRIPTION OF THE DRAWINGS

FIG. 1 is a schematic diagram of a simplified example of a multimap data structure;

FIG. 2 is a schematic diagram of a simplified example of an subgraph of multimap for internal prediction;

FIG. 3 is a schematic diagram of a simplified example of an subgraph of multimap for external prediction; and

FIG. 4 is a schematic diagram of a simplified example of a subgraph of multimap for keyword adjacency prediction.

FIG. 5 is a block diagram of an example computing system for predicting using multimap;

FIG. 6 is a process flow diagram describing an example method for predicting using multimap; and

FIG. 7 is a block diagram showing tangible, non-transitory computer-readable medium that stores code for predicting using multimap.

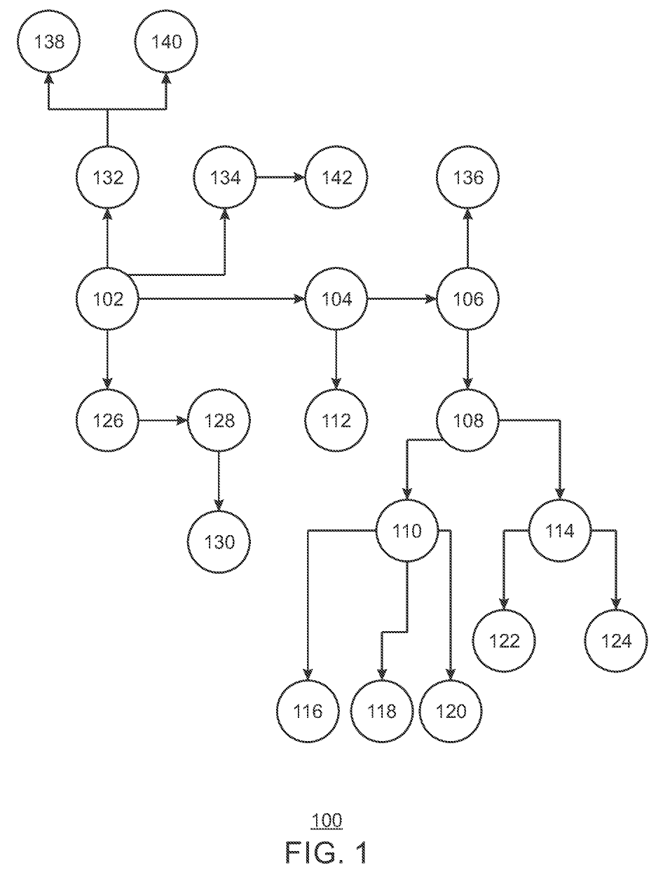

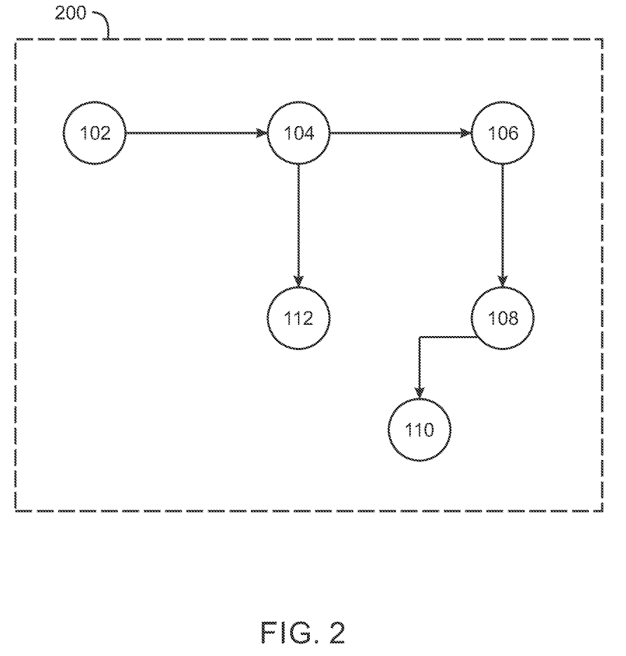

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EXAMPLES

The present techniques relate to a framework for fast and efficient prediction about the next activity of an individual and their preferences based on the past activities of similar users. These preferences can be for a product the user may wish to buy, a predictive text a user may want to input, or similar actions or items for presentation to a user. Similarly, prediction can be used for predicting locations a desirable for travel based on past actions or identify and analyze a health problem. For these and similar applications, the techniques disclosed provide highly accurate recommendation by combining both the past activities of individuals and the features of the objects or ideas to be predicted.

In an example, when a computer user is browsing different websites and online stores for products to purchase, the computer user may have a difficult time efficiently finding products that are potentially interesting to them. Using prediction based on multimap data structures and a matched user profile, can assist the individual in finding products of interest. As used herein, a multimap can be a map or associative array abstract data type in which more than one value may be associated with and returned for a given key. The multimap can be a container that can be implemented as a map with lists or sets as the map values. The multimap prediction can be, in part, based on matching the users profile with others users with a similar profile as represented in a multimap.

Present recommendation engines are constrained to learning static models to get recommendation in real time. These static models do not allow recommendation engines to easily add new products to market without training a new model including this new product and then learning the updated model. The process for training a new model is a time consuming process as this process can be based on the results of many users' actions that include the new product.

The presently disclosed techniques allow the merging of new products in to a predictive data structure through the use of a multimap data structure in prediction. The use of a multimap data structure a recommendation engine to make a prediction, even for a new product, without any human intervention or retraining of a model based on keywords of the products being added as new nodes of the multimap. Further, the use of a multimap data structure does not reveal any personalized information as the user profile mapping for prediction can involve extracting only keywords from past activities of an individual on mobile. While the predictions discussed herein may use the example of predicting particular products a user may be likely to purchase, the presently disclosed prediction techniques can also be suitable for use in prediction in other domains like medical, financial, travel, and banking.

In the following disclosure, numerous specific details are set forth, such as examples of specific types of processors and system configurations, specific hardware structures, specific instruction types, specific system components, etc. in order to provide a thorough understanding of the present disclosure. It can be apparent, however, to one skilled in the art that these specific details need not be employed to practice the presently disclosed techniques. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the presently disclosed techniques.

Although the following examples may be described with reference to prediction using a multimap data structure in specific integrated circuits, such as in computing platforms or microprocessors, other examples are applicable to other types of integrated circuits and logic devices. Similar techniques and teachings of examples described herein may be applied to other types of circuits or semiconductor devices that may also benefit from prediction using a multimap data structure. For example, the disclosed examples are not limited to desktop computer systems or Ultrabooks™. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below.

Moreover, the apparatus′, methods, and systems described herein are not limited to physical computing devices, but may also relate to software optimizations for predictions based on a multimap structure. As can become readily apparent in the description below, the examples of methods, apparatus′, and systems described herein (whether in reference to hardware, firmware, software, or a combination thereof) can improve efficiency and add to a ‘green technology’ future balanced with performance considerations.

FIG. 1 is a schematic diagram of a simplified example of a multimap data structure 100. In this schematic diagram, each of the nodes 102-140 is represented by a circle. The arrows drawn from one node to another represent edges between nodes. The directionality of the arrows indicates that the node the arrow departs from is a key and the node the arrow arrives at is a value. For example, node 104 is a key node to the value nodes 106 and 112. Node 106 however is a key for value nodes 108 and 136. Outside the multimap graph, the key to value relationship is formed by the key representing a first user action or keyword with its corresponding value being the next action a user performs or the next keyword accessed or returned.

In some examples of multimap graphs for prediction, a main graph size can be plotted with a node for a user's past activities, a node for all users' activities, and a node for each product reviews or keywords for prediction. The keywords or product reviews can be replaced by other values depending on the industry or type of prediction being made using multimap. In an example, a main multimap graph can include 200,000 nodes each representing various actions, keywords, and products. This data structure can be updated constantly as new orders of operations are performed by users and as more actions lead to the access of different products or product keywords. The multimap data structure allows the addition of values or keys to a particular node without disrupting the rest of the multimap data structure. The ability to add new products, user actions, and keywords through the addition of new key nodes or value nodes allows the use of this data structure without remaking from scratch the graph for each update in these parameters.

When using the multimap data structure for prediction, the full multimap graph can often be unreasonably large to benefit a user. Rather than needing every action or keyword of a multimap graph, the user may be find more use by targeting a subgraph of the main multimap graph that roughly matches the users own experience.

To determine this, a user's own actions and keywords and products accessed in a limited time frame can be used to form a user profile graph. The limited time frame can be the most recent period of time as a user's next actions are often more closely aligned to their previous action and results. In another example, the limited time frame can be a time frame corresponding to the most recent user use during a similar time of day, time of week, time of month, or time of year as in some cases, a user's likely actions during similar time periods can be cyclical in nature. The limited time frame can be three hours of the most recent use, the limited time frame can be several minutes of use that occurs each morning. During this time period the user's actions, the next actions, and all intervening products or keywords can be recorded and used to form a user profile graph having nodes and edges with key nodes and value nodes. This user profile graph can then be matched, or roughly matched to a subgraph of the main graph.

The subgraph of the multimap graph can include a closest approximation of the user's potential actions or keywords based on the user's previous actions compared to the user action input nodes stored in the main multimap. Each node in the multimap and the subgraph of the multimap graph can store actions and can be connected by an edge to a second node, a value node, with another action or keyword that can be returned as a prediction. This subgraph of the multimap graph can be much smaller in size as it has been matched from user action and keywords from only a limited time frame. This subgraph of the multimap graph can be sent or downloaded by a device to make the prediction on a repeating basis. For example, the subgraph of the multimap graph can be sent to a device every twenty four hours. The subgraph of the multimap graph can replace entirely a previous subgraph or add to a previous subgraph. When a subgraph of the multimap replaces a previous subgraph of a multimap stored on a device, this replacement can allow more accurate or faster results. In some examples, the prediction of an updated subgraph of a multimap can be made on the smaller set of data of a replacement subgraph that can be more closely tailored to a user profile graph from a recent or related limited time frame.

FIG. 2 is a schematic diagram of a simplified example of a subgraph of multimap for internal prediction. Like numbered items are as described in FIG. 1. Further, an internal prediction is one type of prediction that can be used using a multimap data structure to predict next action, products, or nodes to be accessed by a user. The internal prediction can be based on the key nodes that are keys on a path for multiple user actions analyzed for a prediction.

To make an internal prediction, the user activity from the limited time frame can be searched one action at a time for each of that particular actions key values. If each user action can be represented as a node, then whether it is a key node or a value node, a search can be performed to determine what other nodes may be the key nodes for it using a backtracking process that follows the arrows backwards through a subgraph of a multimap for internal prediction 500. This backtracking can be done recursively, returning each value of the nodes it finds, then using those values and backtracking another level to find that value node's key with each result being stored in a hashmap. This process can be done until an orphan node is reached. An orphan node is a node in the subgraph of the multimap that has no key node. As seen in FIG. 2, node 102 is an orphan node as no other nodes act as its key value as no nodes have edges that lead to node 102.

As an example of this first step of making an internal prediction, user actions stored in node 110 and node 112 can be the most recent two actions performed by a user and may be submitted to make a prediction of a next user action or product a user may want. Using an internal prediction, the first step would involves searching node 110 as value on the subgraph of the multimap for internal prediction 200 using recursive backtracking to find the key for its value and storing these values in a first hashmap data structure in memory referred to as hashmap A. In an example, the node 110 can find its key node 108 and store node 108 in hashmap A. Hashmap A can include the node as well as a completion marker to indicate that a particular node has complete a backtracking step. In an example, the node 108 can then be used as the value node and its parent node sought, in this example, node 106, which would then be stored in hashmap A. The hashmap value for node 108 can then be marked complete and the backtracking can proceed until an orphan node is reached. In this example, the backtracking can stop at node 102, because node 102 is an orphan node as no edge is coming into node 102. After the backtracking for node 110 is complete, the resulting hashmap A for user activity node 110 is {108, 106, 104, 102}.

Likewise, as an internal prediction is being made between at least two nodes of the subgraph of the multimap graph 200, a second node, for example node 112, can follow the same backtracking process as mentioned for node 110 with each key being stored in a separate storage as hashmap-B. At the end, the resulting hashmap for the user activity represented by node 112 is {104, 102}. This process of generating hashmaps can be done for any number of user actions corresponding to nodes on the subgraph of the multimap for internal prediction 200.

To make the internal prediction, the hashmaps from each can be interested. The intersecting of two hashmaps results in an overlap hashmap which includes values common in both hashmap A and hashmap B. In this example, the overlap hashmap, hashmap C, is {104, 102} as both hashmap A and hashmap B contained these values.

If more than two user actions, or nodes, are being used to make an internal prediction, then an intersection may be done between the first and second hashmaps, second and third hashmaps, third and fourth hashmaps and so on, while appending each intersect result into the same resulting hashmap, hashmap C. From this overlap hashmap C, the first node of the hashmap, here represented as 104, which is checked against the most recent activity, here represented by node 112. If an edge path exists between these two nodes, then source node 104 is given as an internal prediction.

In cases where a path does not exist between a source and destination then the second node in the hashmap C replaces the source node and another depth-first search algorithm is performed to determine if a path exists between the source node and the most recent user action represented by node 112. This process is determined recursively until either an internal prediction can be made, or until it is determined that there is no path between the source nodes and the user actions.

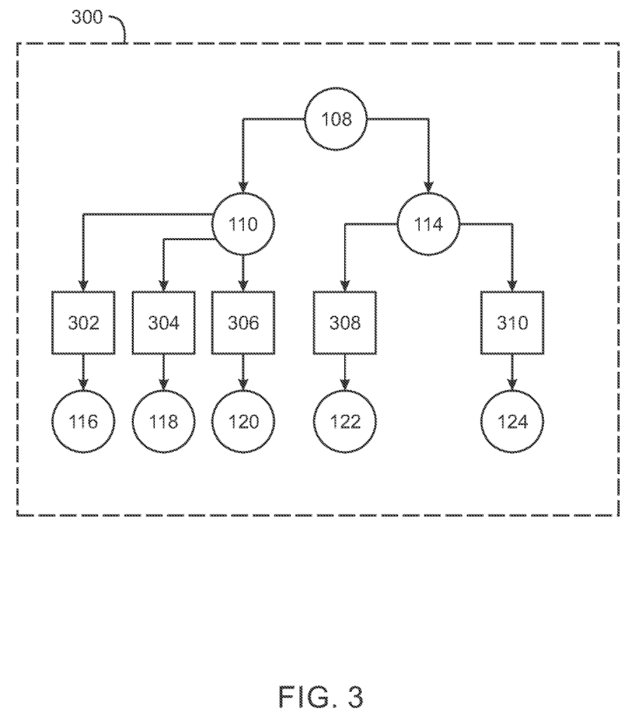

FIG. 3 is a schematic diagram of a simplified example of a subgraph of multimap for external prediction 300. Like numbered items are as described in FIG. 1.

External prediction is a prediction for multiple actions or keywords that move outward, or external from a multimap graph. In external prediction, the limited time frame of a user activity can again be used for user activities to be taken one by one and corresponded to a subgraph of the multimap for external prediction 300. In an example of external prediction, user actions represented by node 110 and node 114 can be input at key nodes to find the corresponding value nodes. In FIG. 3, the value nodes for 110 include node 116, node 118, and node 120. The value nodes for node 114 include node 122 and 124. As discussed above, each node connection can be referred to as an edge. These edges can have values associated with them called edge weights. As seen in FIG. 3, the edge between node 110 and 116 can have an edge weight 302. Similarly, edge weights 304-310 exist for each of the edges shown between the other nodes in the subgraph of the multimap for external prediction. While edge weights are shown in FIG. 3, these weights can be present for all edges in a multimap. In an example, the edge weights represent a frequency a key node leads to the value node relative to the other value nodes attached. Therefore, if a node has only one value node connected, the edge weight of that connecting edge might be 1, where if two nodes flowed from the same node and were equally accessed, their edge weights might be 0.5 and 0.5 respectively. As the frequency of access from one key to a value node changes, these edge weight value can be updated to reflect how often a particular node, or user action, or keyword will lead to another specific keyword or action.

In this external prediction example, both user actions are represented by nodes 110 and 112 and can generate the value nodes 116, 118, and 120 for key node 110 and value nodes 122 and 124 for key node 114. Each of these edges or connections can include edge weights 302-310. In this external prediction example, only one degree of depth search is performed however, in other versions of external prediction other depths can be used as well. For exemplary purpose, edge weight 302 is 0.8, edge weight 304 is 0.29, and edge weight 306 is 0.19 where the edge weight value represents a frequency that a particular user action can lead to a value node of another action or a keyword. The edge weights for a single key node may not add up to 1 and also may exceed one in terms of their frequency as some key nodes may return more than one result per action. For exemplary purpose, edge weight 308 is 0.88 and edge weight 310 is 0.71.

As the one degree depth external search has been done, the comparison of edge weights at that depth can provide the external prediction. In this example, as edge weight 308 is highest at 0.88 between all other nodes at this one degree depth from nodes 110 and 114, the value node 122 is chosen as the external prediction.

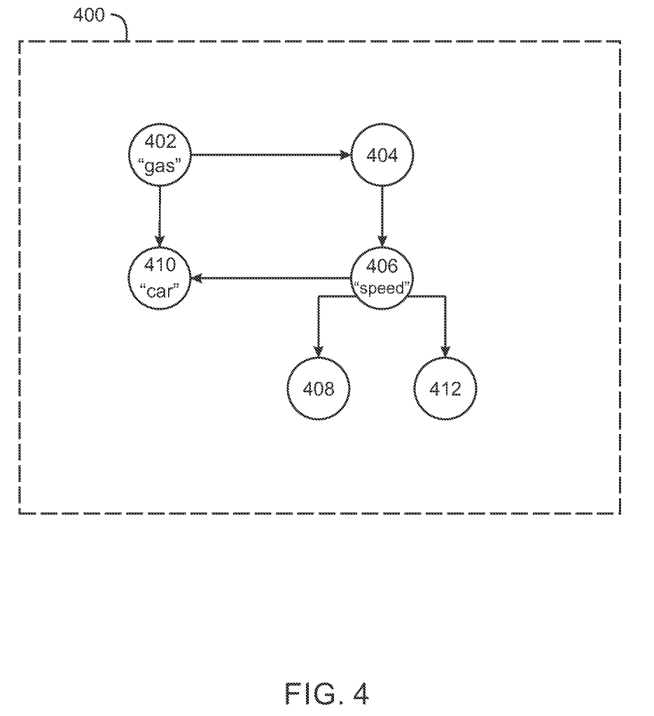

FIG. 4 is a schematic diagram of a simplified example of a subgraph of multimap for keyword adjacency prediction 400. This keyword adjacency prediction can refer to a prediction of a product for purchase, and can also refer to a prediction based on keywords for a number of technologies.

A subgraph for keyword adjacency prediction can be generated from an automated read-in of all products in a set of product catalogues or from a resource that collects or offers a large number of products for sale such as an online store or marketplace. The read-in of these products can include the creation of a subgraph for keyword adjacency prediction by analyzing any product information associated with the product and the determination of keywords. This determination of keywords can be accomplished by a Text-Rank method that finds keywords by frequency or place in a sentence or paragraph, for example. When keywords are determined an adjacency list can be prepared between products and keywords where product and keyword has a separate node, but particularly relevant products and keywords are joined by an edge. In another example, an adjacency list can prepared for products and their associated keywords as nodes with edge weight for each keyword node, where the keyword node can act as key and products can act as value in a value node.

When performing a prediction using a multimap and keyword adjacency, a user's actions and activity can be collected and from most recent to least recent checked to see if these actions include keywords. If a user action input is a keyword, a product prediction can use the product-keyword adjacency graph created by the analysis and adjacency of keywords and products. As stated above, each keyword can act as a key for a product so assuming, for example, the keywords “speed” in node 406, and “gas” in node 402 are part of user's recent activity, a prediction can be made for a product. The recency of the user action can be part of a limited time frame or part of a recurring time segment that increases the likelihood that a particular action and keyword is related to a particular product.

Starting with the two keywords “speed” and “gas” in a user action input, the subgraph from a larger multimap graph can be obtained that corresponds to other user's actions that have previously been recorded and stored in a multimap data structure. Using the terms provided by user's recent activity, a subgraph of the multimap for keyword adjacency prediction can be obtained for searching. In an example, this subgraph of the multimap graph can include all nodes between the two terms or user actions, the subgraph of the multimap graph can also include all nodes of one degree distance, two degree distance, or other suitable distance from the keyword nodes.

In the subgraph of the multimap graph containing these two keywords as nodes, a count can be made for how edges come out from each user action input nodes node, here each containing a keyword. In FIG. 4, two edges are coming out from user action input node 402, and three edges are coming out from user action input node 406. This counting of nodes can take place for all user action input nodes whose type is keyword and how they connect to products or other nodes. When predicting a product, each product node, here represented by nodes 410, 404, 408, and 412 can use the above edge counts to determine how many edges from user action input nodes, or keywords, are incoming to their own node. For node 410, the node has incoming edges from two different user action input nodes, node 402, and node 406. Having two incoming edges from different keywords is relatively higher than nodes 404, 408, and 412. Accordingly, the value of node 410 is returned as a keyword adjacency prediction, in this case the value “car” is returned from node 410. In this case, either the keyword “car” or the product “car” can be returned depending on the type of prediction requested.

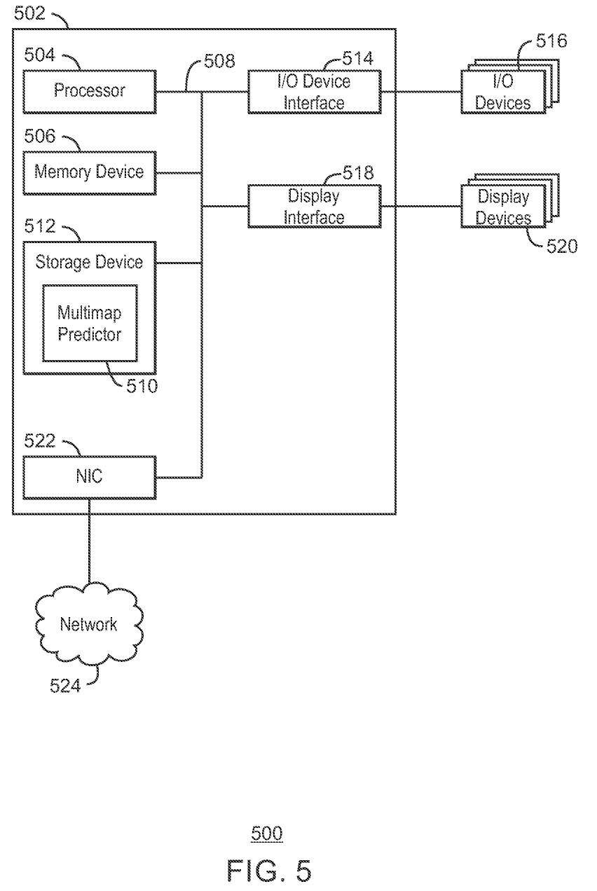

FIG. 5 is a block diagram of an example computing system 502 for predicting using multimap. The computing system 502 may be components of, for example, a computing device such as a laptop computer, desktop computer, Ultrabook, tablet computer, mobile device, mobile phone, or server, among others. The computing system 502 may include a central processing unit (CPU) 504 that is configured to execute stored instructions, as well as a memory device 506 that stores instructions that are executable by the CPU 504. The CPU may be coupled to the memory device 506 by a bus 508. Additionally, the CPU 504 can be a single core processor, a multi-core processor, a computing cluster, or any number of other configurations. Furthermore, the computing system 502 may include more than one CPU 504. The computing system 502 may also include a graphics processing unit (GPU). The CPU 504 may be coupled through the bus 508 to the GPU. The GPU may be configured to perform any number of graphics functions and actions. For example, the GPU may be configured to render or manipulate graphics images, graphics frames, videos, or the like, to be displayed to a user of the computing system 502. The memory device 506 can include random access memory (RAM), read only memory (ROM), flash memory, or any other suitable memory systems. For example, the memory device 506 may include dynamic random access memory (DRAM).

A multimap predictor 510 can be stored in a storage device 512 coupled with the computing system 502. The storage device may be a component located on the computing system 502. Additionally, the storage device 512 can be a physical memory such as a hard drive, an optical drive, a thumb drive, an array of drives, or any combinations thereof. The storage device 512 may also include remote storage drives. The multimap predictor 510 can be logic at least in part implemented in an integrated circuit. The multimap predictor 510 can predict a next activity or product preference based on an individual profile generated by received user input. The multimap predictor 510 can access both a multimap stored on the memory device 506 and can also generate a user profile based on the user input received through an I/O device interface 514 from an I/O device 516. The multimap can be a map or associative array abstract data type in which more than one value may be associated with and returned for a given key. The multimap can be a container that can be implemented as a map with lists or sets as the map values. After generating a user profile in a graphical form, a multimap predictor 510 can match this user profile graph to a similar segment of a larger multimap generated based on a global set of users actions. From this matching and based on user action input, the multimap predictor can predict a product or action for the user based on the subgraph of the multimap corresponding to the user profile graph.

The CPU 504 can be connected through the bus 508 to the input/output (I/O) device interface 514 and configured to connect with one or more I/O devices 516. The I/O devices 516 may include, for example, a keyboard and a pointing device, wherein the pointing device may include a touchpad or a touchscreen, among others. The I/O devices 516 may be built-in components of a platform including the computing system 502, or may be devices that are externally connected to a platform including the computing system 502. In an example, the I/O devices 516 may be a keyboard or a pointing device that is coupled with the I/O device interface 514.

The CPU 504 may also be linked through the bus 508 to a display interface 518 configured to connect with one or more display devices 520. The display devices 520 may include a screen that is a built-in component of a platform including the computing system 502. Examples of such a computing device include mobile computing devices, such as cell phones, tablets, 2-in-1 computers, notebook computers or the like. The display device 520 may also include a computer monitor, television, or projector, among others, that is externally connected to the computing system 502.

The computing system 502 may also include a network interface controller (NIC) 522 may be configured to connect the computing system 502 through the bus 508, various layers of the computing system 502, and components of the computing system 502 to a network 524. The network 524 may be a wide area network (WAN), local area network (LAN), or the Internet, among others. The computing system 502 can also be coupled to a storage interface configured to connect to at least one external storage. The storage interface can include an interface for secure digital cards, external hard drives, external flash drives, or other types of external data storage devices that can act as external storage.

It is to be understood that the block diagram of FIG. 5 is not intended to indicate that the computing system 502 is to include all of the components shown in FIG. 5. Rather, the computing system 502 can include fewer or additional components not illustrated in FIG. 5. Furthermore, the components may be coupled to one another according to any suitable system architecture, including the system architecture shown in FIG. 5 or any other suitable system architecture that uses a data bus to facilitate communications between components. For example, the present techniques can also be implemented any suitable electronic device, including ultra-compact form factor devices, such as computing system and multi-chip modules.

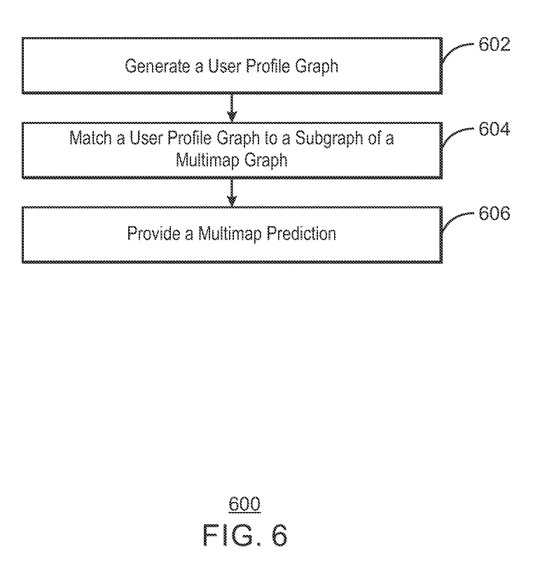

FIG. 6 is a process flow diagram describing an example method 600 for predicting using multimap. Process flow begins at block 602. At block 602, the method of multimap prediction can include generating a user profile graph in the memory device based on user action input received at an input device. The user profile graph can be a data structure arranged in a graph or map form or other suitable form to be compared to a multimap. In an example, the user action input received is based on user action that has occurred in a limited time frame. A user action to be included in either a user profile graph or in a multimap can include any action a user makes with a device or a device undertakes. For example, a user action input can include keywords that are typed or received. A user action input can also include actions of the device resulting from a user's actions such as a power on, the opening of a particular application, a purchase of a particular product, or any other action in the device. If a user's activity for the past three or four hours has been recorded, one of those time frames can be used to determine the collection of user action input that can be sent to a memory device to form a user profile graph. As discussed herein, the user profile graph can be a collection of items and actions in a map data format, graph data format, or any other suitable data structure suitable for comparison to corresponding information in a multimap.

At block 604, a user profile graph stored in the memory device can be matched to a subgraph of a multimap graph. In an example, both the user profile graph and the subgraph of the multimap graph include nodes and edges. Each node can indicate an activity input corresponding to a user action input received. As discussed above, each node can indicated actions such as power on, opening of an application, or a purchase or viewing of a particular page or product. Each node can also indicate a particular keyword or other representation of particular product. As these nodes are created to represent these objects, edges can be created to link a node to a second node based on the order of the actions taken. Similarly, an edge can be created if one keyword follows an action, or if one keyword follows another keyword.

At block 606, access can be provided to a multimap prediction in the memory device based on the user action input and the subgraph of the multimap graph. When a prediction is made based on user action input, this includes recent data that a user has generated through their use of a device. The subgraph of the multimap graph can be used to compare user action to the nodes of the multimap graph to aid in prediction of a next action, keyword, or product. In an example, the multimap prediction can be an internal prediction made by intersecting multiple attached key hashmaps. These key hashmaps can each be generated by identifying keys attached to nodes that have been backtracked from each user action input received. Intersecting the values generated in the hashmaps shows overlap of keywords and actions from the a user action input nodes and increase the likelihood that a user action input will have a particular prediction result. FIG. 6 shows additional elaboration on one technique of internal prediction with multimap, key hashmaps, and similar data.

In an example, the multimap prediction can be an external prediction made according to an edge weight of the subgraph of the multimap graph. The use of edge weights can indicate a frequency a particular node leads to a second node. A higher edge weight can be relatively determined by comparison to a second edge weight from a second node. In the present techniques, multimap predictions can be made using edge weights between a first node nodes that corresponds to a user action input acting as a key and a second node where a value node is in the path corresponding to the first node. These edge weights may be between nodes on the subgraph of the multimap graph. By comparing these edge weights, a more likely prediction can be made by selecting the edge weight corresponding to a higher tendency of users to select the action or product in a particular node. In an example, the value node in the path corresponding to the key is one degree depth from the node corresponding to the user action input. By limiting the degree depth, and keeping the degree depth consistent between edge weight comparisons, the techniques for prediction can use comparable values. FIG. 3 has further discussion and illustration of external prediction based on multimap.

In an example, the multimap prediction can be a keyword adjacency prediction made according to an edge count for user action input nodes. A keyword adjacency prediction assumes that the nodes being considered are both keywords that correspond to a product, rather than, for example, a user action. When comparable nodes are identified in the subgraph of the multimap, the edge count from each can be counted for comparison and to determine which of multiple keyword nodes has the highest edge count. The edge count can correspond to both a node in the subgraph of the multimap graph and the edges generated from user actions acting as key nodes in the subgraph of the multimap graph. FIG. 4 has further discussion and illustration of keyword adjacency prediction based on multimap.

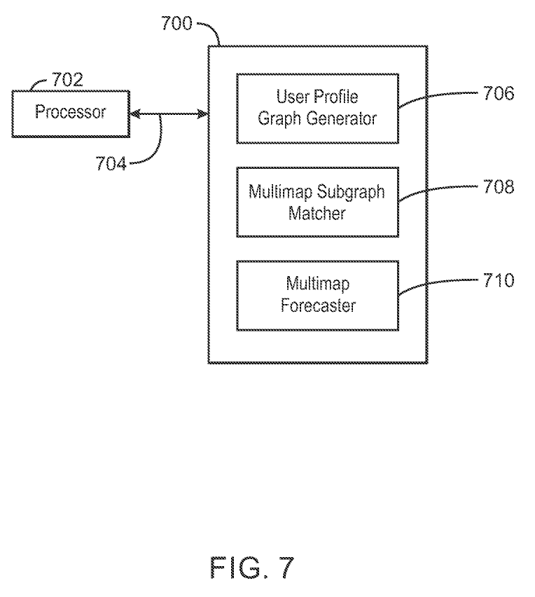

FIG. 7 is a block diagram showing tangible, non-transitory computer-readable medium that stores code for predicting using multimap. The tangible, non-transitory computer-readable medium 700 may be accessed by a processor 702 over a computer bus 704. Furthermore, the tangible, non-transitory computer-readable medium 700 may include code configured to direct the processor 702 to perform the methods described herein. The code can be implemented in modules, memory devices, or any other suitable store that includes, at some cases, an integrated circuit.

The computer-readable medium can include instructions to direct the processor to generate a multimap prediction. The computer-readable medium includes a user profile graph generator 706 to generate a user profile graph based on user action input received at an input device.

The computer-readable medium can include a multimap subgraph matcher 708. The multimap subgraph matcher 708 can match a user profile graph to a subgraph of a multimap graph. Both the user profile graph and the subgraph of the multimap graph include nodes and edges. Each node indicates either an activity input or can indicate a keyword.

The computer-readable medium can include a multimap forecaster 710. The multimap forecaster 710 provides a multimap prediction based on the user action input and the subgraph of the multimap graph. The multimap prediction can be an internal prediction made by intersecting multiple attached key hashmaps each generated by identifying attached keys through backtracking nodes for each user action input received. The multimap prediction can also be an external prediction made according to an edge weight that is relatively higher when compared to a second edge weight, wherein both edge weights are between a node corresponding to the user action input acting as a key and a value node in the path corresponding to the key. The multimap prediction can also be a keyword adjacency prediction made according to an edge count for user action input nodes that is relatively higher when compared to a second edge count for user action input that are keywords. Each of these various types of multimap predictions are discussed and illustrated in FIGS. 2, 3, and 4.

The block diagram of FIG. 7 is not intended to indicate that the tangible, non-transitory computer-readable medium 700 is to include all of the components shown in FIG. 7. Further, the tangible, non-transitory computer-readable medium 700 may include any number of additional components not shown in FIG. 7, depending on the details of the specific implementation.

### EXAMPLES

Example 1 is a method of multimap prediction. The method includes generating a user profile graph in the memory device based on user action input received at an input device; matching a user profile graph stored in the memory device to a subgraph of a multimap graph, both comprising nodes and edges, wherein each node indicates at least one of an activity input and a keyword; and providing access to a multimap prediction in the memory device based on the user action input and the subgraph of the multimap graph.

Example 2 includes the method of example 1, including or excluding optional features. In this example, the multimap prediction is an internal prediction made by intersecting multiple attached key hashmaps each generated by identifying attached keys through backtracking nodes for each user action input received. Optionally, the user action input received is based on user action that has occurred in a limited time frame.

Example 3 includes the method of any one of examples 1 to 2, including or excluding optional features. In this example, the multimap prediction is an external prediction made according to an edge weight that is relatively higher when compared to a second edge weight, wherein both edge weights are between a node corresponding to the user action input acting as a key and a value node in the path corresponding to the key. Optionally, the edge weights are between nodes on the subgraph of the multimap graph. Optionally, the value node in the path corresponding to the key is one degree depth from the node corresponding to the user action input.

Example 4 includes the method of any one of examples 1 to 3, including or excluding optional features. In this example, the multimap prediction is a keyword adjacency prediction made according to an edge count for user action input nodes that is relatively higher when compared to a second edge count for user action input that are keywords. Optionally, the edge count corresponds to both a node in the subgraph of the multimap graph and edges generated from user actions acting as key nodes in the subgraph of the multimap graph.

Example 5 is a system for predictive data using multimap. The system includes an input device to receive user action input; a memory device to store the user action input; a processor to generate a user profile graph and match the user profile graph to a subgraph of a multimap graph, both comprising nodes and edges, wherein each node indicates at least on of an activity input and a keyword; and wherein the processor provides a multimap prediction based on the user action input and the subgraph of the multimap graph.

Example 6 includes the system of example 5, including or excluding optional features. In this example, the multimap prediction is an internal prediction made by intersecting multiple attached key hashmaps each generated by identifying attached keys through backtracking nodes for each user action input received. Optionally, the user action input received is based on user action that has occurred in a limited time frame.

Example 7 includes the system of any one of examples 5 to 6, including or excluding optional features. In this example, the multimap prediction is an external prediction made according to an edge weight that is relatively higher when compared to a second edge weight, wherein both edge weights are between a node corresponding to the user action input acting as a key and a value node in the path corresponding to the key. Optionally, the edge weights are between nodes on the subgraph of the multimap graph. Optionally, the value node in the path corresponding to the key is one degree depth from the node corresponding to the user action input.

Example 8 includes the system of any one of examples 5 to 7, including or excluding optional features. In this example, the multimap prediction is a keyword adjacency prediction made according to an edge count for user action input nodes that is relatively higher when compared to a second edge count for user action input that are keywords. Optionally, the edge count corresponds to both a node in the subgraph of the multimap graph and the edge count comprises edges generated from user actions acting as key nodes in the subgraph of the multimap graph.

Example 9 is a tangible, non-transitory, computer-readable medium comprising instructions that, when executed by a processor, direct the processor to generate a multimap prediction. The computer-readable medium includes instructions that direct the processor to generate a user profile graph based on user action input received at an input device; match a user profile graph to a subgraph of a multimap graph, both comprising nodes and edges, wherein each node indicates at least one of an activity input and a keyword; and provide a multimap prediction based on the user action input and the subgraph of the multimap graph.

Example 10 includes the computer-readable medium of example 9, including or excluding optional features. In this example, the multimap prediction is an internal prediction made by intersecting multiple attached key hashmaps each generated by identifying attached keys through backtracking nodes for each user action input received.

Example 11 includes the computer-readable medium of any one of examples 9 to 10, including or excluding optional features. In this example, the multimap prediction is an external prediction made according to an edge weight that is relatively higher when compared to a second edge weight, wherein both edge weights are between a node corresponding to the user action input acting as a key and a value node in the path corresponding to the key.

Example 12 includes the computer-readable medium of any one of examples 9 to 11, including or excluding optional features. In this example, the multimap prediction is a keyword adjacency prediction made according to an edge count for user action input nodes that is relatively higher when compared to a second edge count for user action input that are keywords.

While the present techniques have been described with respect to a limited number of examples, those skilled in the art can appreciate numerous modifications and variations therefrom. It is intended that the appended claims cover all such modifications and variations as fall within the true spirit and scope of this present techniques.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one example, refers to the hardware, which is specifically configured to recognize and/or execute the code to be held on a non-transitory medium. Furthermore, in another example, use of a module refers to the non-transitory medium including the code, which is specifically adapted to be executed by the microcontroller to perform predetermined operations. And as can be inferred, in yet another example, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one example, use of the term logic includes hardware, such as transistors, registers, or other hardware, such as programmable logic devices.

The examples of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform examples of the present techniques may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

In the foregoing specification, a detailed description has been given with reference to specific examples. It can, however, be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of example and other language does not necessarily refer to the same example or the same example, but may refer to different and distinct examples, as well as potentially the same example.

What is claimed is:

1. A method of multimap prediction, comprising:
generating a user profile graph in a memory device based on a user action input to be received at an input device;
matching the user profile graph to be stored in the memory device to a subgraph of a multimap graph, both comprising nodes and edges, wherein each node indicates at least one of an activity input and a keyword; and
providing access to a multimap prediction in the memory device based on the user action input and the subgraph of the multimap graph.

2. The method of claim 1, wherein the multimap prediction is an internal prediction made by intersecting multiple attached key hashmaps each generated by identifying attached keys through backtracking nodes for each user action input received.

3. The method of claim 2, wherein the user action input received is based on user action that has occurred in a limited time frame.

4. The method of claim 1, wherein the multimap prediction is an external prediction made according to an edge weight that is relatively higher when compared to a second edge weight, wherein both edge weights are between a key node corresponding to the user action input acting as a key and a value node in a path corresponding to the key.

5. The method of claim 4, wherein the edge weight is between nodes on the subgraph of the multimap graph.

6. The method of claim 4, wherein the value node in the path corresponding to the key is one degree depth from the node corresponding to the user action input.

7. The method of claim 1, wherein the multimap prediction is a keyword adjacency prediction made according to an edge count for user action input nodes that is relatively higher when compared to a second edge count for user action input that are keywords.

8. The method of claim 7, wherein the edge count corresponds to both a node in the subgraph of the multimap graph and edges generated from user actions acting as key nodes in the subgraph of the multimap graph.

9. A system for predictive data using multimap comprising:
an input device to receive user action input;
a memory device to store the user action input;
a processor to generate a user profile graph and match the user profile graph to a subgraph of a multimap graph, both comprising nodes and edges, wherein each node indicates at least on of an activity input and a keyword; and
wherein the processor is to provide a multimap prediction based on the user action input and the subgraph of the multimap graph.

10. The system of claim 9, wherein the multimap prediction is an internal prediction made by intersecting multiple attached key hashmaps each generated by identifying attached keys through backtracking nodes for each user action input to be received.

11. The system of claim 10, wherein the user action input received is based on user action that is to occur in a limited time frame.

12. The system of claim 9, wherein the multimap prediction is an external prediction made according to an edge weight that is relatively higher when compared to a second edge weight, wherein both edge weights are between a key node corresponding to the user action input acting as a key and a value node in a path corresponding to the key.

13. The system of claim 12, wherein the edge weight are between nodes on the subgraph of the multimap graph.

14. The system of claim 12, wherein the value node in the path corresponding to the key is one degree depth from the node corresponding to the user action input.

15. The system of claim 9, wherein the multimap prediction is a keyword adjacency prediction made according to an edge count for user action input nodes that is relatively higher when compared to a second edge count for user action input that are keywords.

16. The system of claim 15, wherein the edge count corresponds to both a node in the subgraph of the multimap graph and the edge count comprises edges to be generated from user actions acting as key nodes in the subgraph of the multimap graph.

17. A tangible, non-transitory, computer-readable medium comprising instructions that, when executed by a processor, direct the processor to generate a multimap prediction, the instructions to direct the processor to:
generate a user profile graph based on user action input to be received at an input device;
match the user profile graph to a subgraph of a multimap graph, both comprising nodes and edges, wherein each node indicates at least one of an activity input and a keyword; and
provide a multimap prediction based on the user action input and the subgraph of the multimap graph.

18. The tangible, non-transitory, computer-readable medium of claim 17, wherein the multimap prediction is an internal prediction made by intersecting multiple attached key hashmaps each generated by identifying attached keys through backtracking nodes for each user action input received.

19. The tangible, non-transitory, computer-readable medium of claim 17, wherein the multimap prediction is an external prediction made according to an edge weight that is relatively higher when compared to a second edge weight, wherein both edge weights are between a key node corresponding to the user action input acting as a key and a value node in a path corresponding to the key.

20. The tangible, non-transitory, computer-readable medium of claim 17, wherein the multimap prediction is a keyword adjacency prediction made according to an edge count for user action input nodes that is relatively higher when compared to a second edge count for user action input that are keywords.
